(19) United States
(12) Patent Application Publication
(10) Pub. No.: US 2010/0059966 A1
(43) Pub. Date: Mar. 11, 2010

(54) BOAT LAUNCHING SYSTEM AND METHOD

(76) Inventor: Ralph J. Ireland, Mankato, MN (US)

Correspondence Address: MERCHANT & GOULD PC, P.O. BOX 2903, MINNEAPOLIS, MN, 55402-0903, US

(21) Appl. No.: 12/208,819

(22) Filed: Sep. 11, 2008

(51) Int. Cl. B60P 3/10; B60R 3/00

(52) U.S. Cl. 280/414.1; 280/163

(57) ABSTRACT

The present disclosure provides a system for loading and unloading a watercraft from a trailer that enables the process to be accomplished without the need to stand on the submerged ground surface. In some embodiments the trailer includes an adjustable platform that provides an area upon which the operator can stand while loading and unloading the watercraft from the trailer. The present disclosure also provides a method of loading and unloading a boat that includes the step of pushing or pulling the boat while standing on a platform that extends from the trailer.

### TECHNICAL FIELD

The present disclosure provides a device and method for facilitating loading and unloading a watercraft from a trailer.

### BACKGROUND

Boats and other watercraft are often stored and transported on wheeled trailers that are configured to be towed behind a motor vehicle. Both loading and unloading boats from such trailers typically involve the initial step of backing the trailer into the water until most of the trailer is submerged. The unloading process typically requires that the operator detach or loosen the securing cable between the boat and the trailer and manually push the boat off the trailer. The loading process typically involves attaching a cable to the boat and cranking the boat onto the trailer. The above-described steps are generally accomplished while the operator is standing in the water adjacent the trailer. Loading and unloading the boat from the water requires the operator to wear shorts and water shoes, which is not preferred in some situations. In addition, the submerged ground surface can be uneven, murky, and difficult to traverse. The present disclosure provides an improved trailer system and method for launching and loading watercraft from a trailer.

### SUMMARY

The present disclosure provides a system for loading and unloading a watercraft from a trailer that enables the process to be accomplished without the need to stand on the submerged ground surface. In some embodiments the trailer includes an adjustable platform that provides an area upon which the operator can stand while loading and unloading the watercraft from the trailer. The present disclosure also provides a method of loading and unloading a boat that includes the step of pushing or pulling the boat while standing on a platform that extends from the trailer.

### BRIEF DESCRIPTION OF THE FIGURES

FIG. 1 is a front perspective view of a trailer system according to an embodiment of the present disclosure with a boat on the trailer with a step extending to both the left and right of the centerline of the trailer;

FIG. 2 is a front left perspective view of the trailer system of FIG. 1 with the step extended to the left of the centerline of the trailer;

FIG. 3 is a rear left perspective view of the trailer system of FIG. 1 with the step extended to the left of the centerline of the trailer;

FIG. 4 is a rear enlarged perspective view of the trailer system of FIG. 1 with the step extending to both the left and the right of the centerline of the trailer;

FIG. 5 is a bottom right perspective of the trailer system of FIG. 1 showing the connection of the step to the chassis of the trailer;

FIG. 6 is an enlarged perspective view of the left end of the step of FIG. 1;

FIG. 7 is an enlarged top perspective view of the trailer system of FIG. 1 showing the connection between the step and the chassis of the trailer;

FIG. 8 is an is an exploded assembly view of the step system of FIG. 1;

FIG. 9 is a partially assembled view of the step system of FIG. 8;

FIG. 10 is a top view of a step member of the step system of FIG. 1;

FIG. 11 is an end view of the step member of the step system of FIG. 1;

FIG. 12 is a top view of the mounting member of the step system of FIG. 1;

FIG. 13 is an end view of the mounting member of the step system of FIG. 1;

FIG. 14 is a perspective view of a portion of the mounting member of FIG. 1;

FIG. 15 is a top perspective view of a mounting plate of an alternative embodiment of a mounting assembly;

FIG. 16 is a top perspective view of an alternative embodiment of the step member; and

FIG. 17 is a top view of a hold down plate of an alternative embodiment of a mounting assembly.

### DETAILED DESCRIPTION

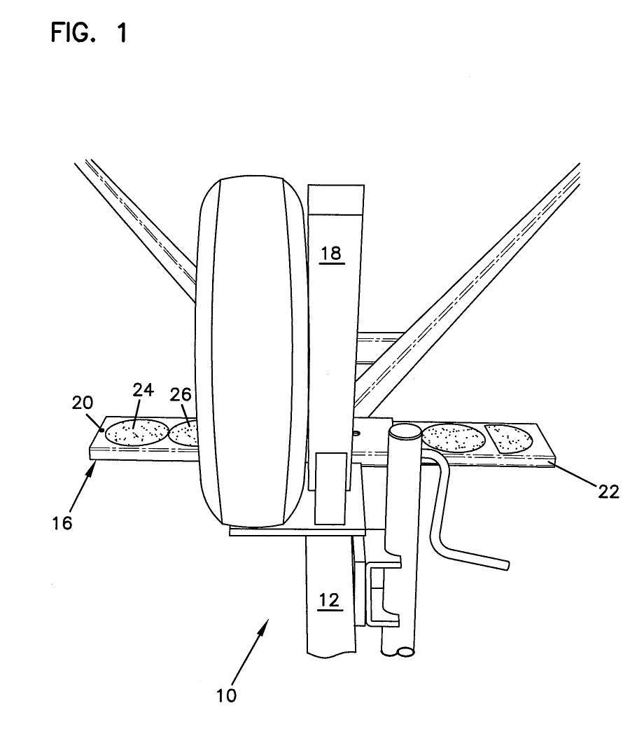

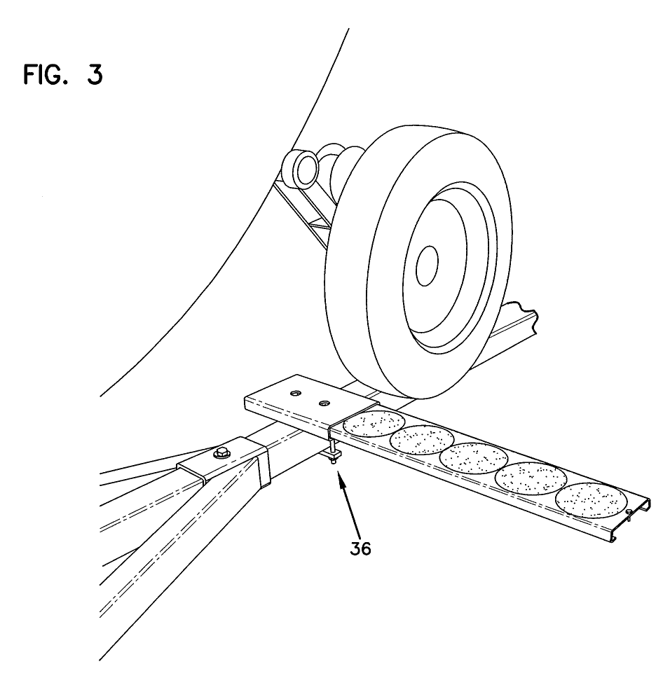

Referring to FIGS. 1-7, an embodiment of a trailer system according to the present disclosure is shown. The trailer system 10 is shown with a first end portion 12 configured to be attached to a motor vehicle and a second end portion 14 supported by wheels. In the depicted embodiment the trailer is a Y-shaped trailer with a plurality of rollers for supporting a fishing boat. In the depicted embodiment the trailer has a winch 18 used to pull the watercraft onto the trailer. It should be appreciated that in alternative embodiments, the trailer can be any other type of trailer.

In the depicted embodiment the trailer system 10 includes a step member 16 that is mounted over the centerline of the trailer chassis. The referred to centerline is the line that divides the left half from the right half of the trailer system 10. In the depicted embodiment the step member 16 is mounted below the trailer winch 18 on the chassis of the trailer. In the depicted embodiment the step member 16 is mounted behind the trailer winch 18, but it should be appreciated that in alternative embodiments the step member 16 could be mounted in front of the winch 18 as well. In the depicted embodiment the position of the step member 16 is adjustable relative to the trailer.

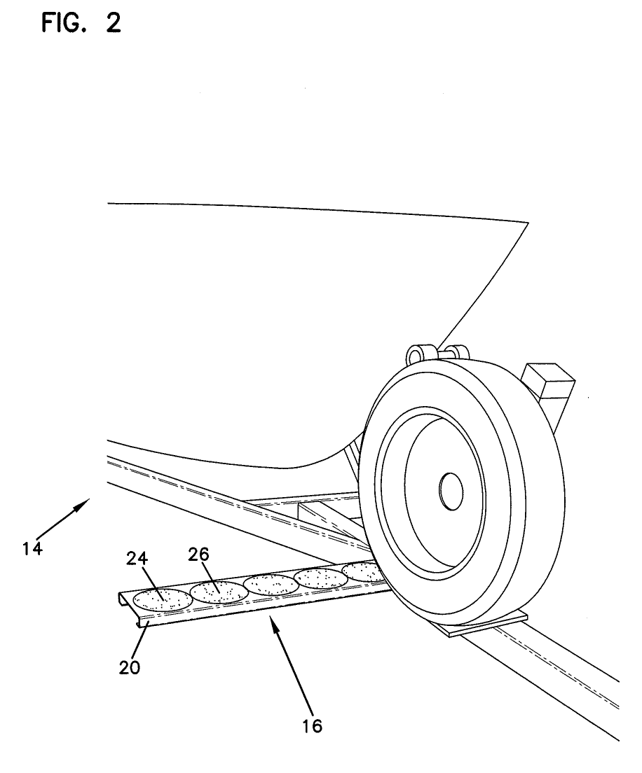

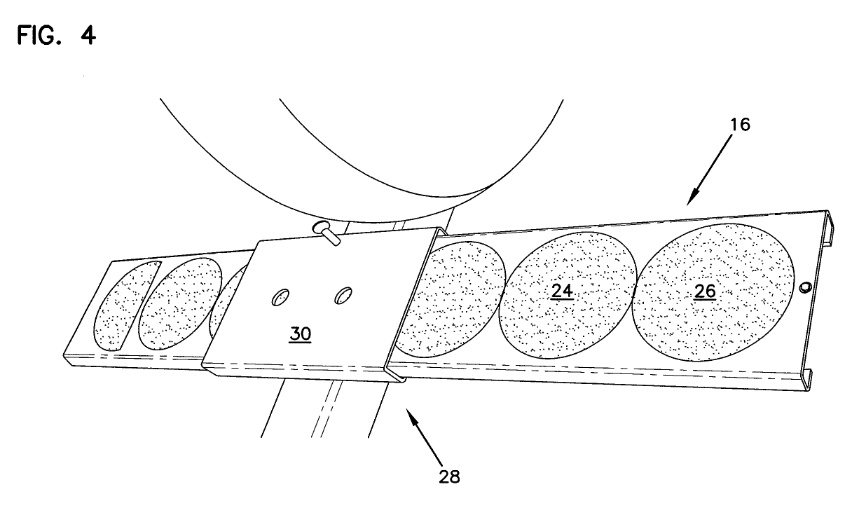

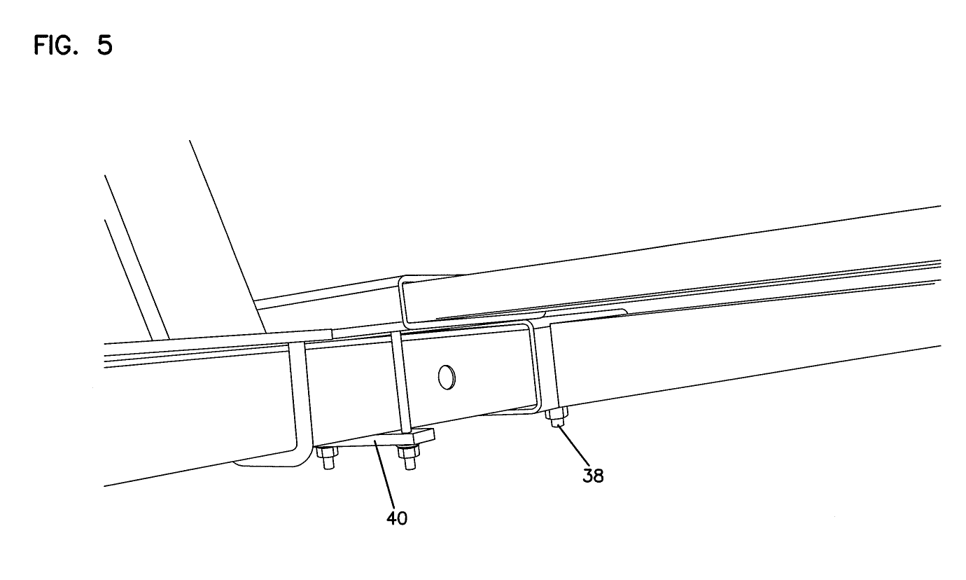

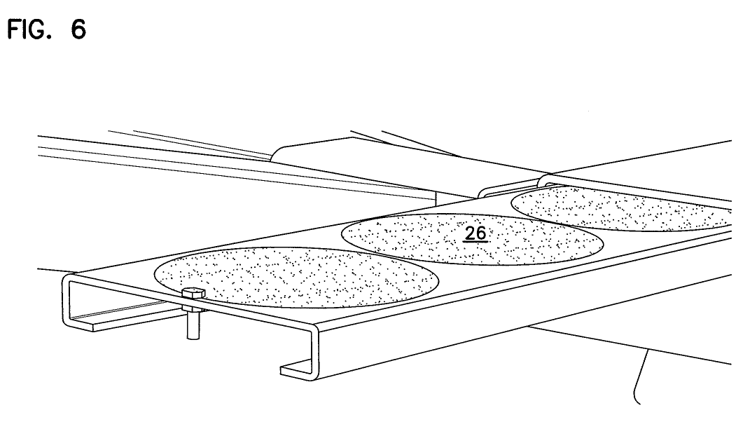

In particular, the step member can be moved front to back (closer to the first end portion 12 or closer to the second end portion 14 as desired by the operator). In the depicted embodiment the position of the step member 16 can also be adjusted side to side so that it extends more or less always from the centerline in either the left or right direction. Referring to FIGS. 1 and 4, the step member 16 is shown centered about the trailer centerline. Referring to FIGS. 2 and 6 the step member 16 is shown adjusted so that it primarily extends to the left of the centerline of the trailer. It should be appreciated that the step member 16 can also be adjusted so that it primarily extends to the right of the centerline of the trailer. The adjustability of the step member 16 allows the user to step onto the step member directly from a dock. If the dock is to the right of the boat launch, the step member can be adjusted to extend to the right towards the dock, whereas if the dock is to the left of the boat launch, the step member can be adjusted to extend to the left toward the dock. It should be appreciated that the operator can also step onto the step members from the water. It should also be appreciated that more than one step member can be attached to a single trailer.

In the depicted embodiment, the step member 16 is shown with grip tape 24 on the upper step surface 26 between the first end 20 and the second end 22 of the step member 16. The grip tape 24 is for providing a textured surface to prevent slipping, as the step member 16 could in some launch scenarios be wet or even submerged in water. It should be appreciated that many alternatives to grip tape are also possible including, for example, abrasive paint, rubber coating, knurled finish, machined grooves on the step surface, etc.

Referring to FIGS. 4-7, the step mounting assembly is described in greater detail. In the depicted embodiment the step mounting assembly 28 includes a sleeve 30 in which the step member 16 can slide side to side therein. In the depicted embodiment the step member 16 has a generally U-shaped cross section and the sleeve 30 has a generally box shaped cross section, wherein some of the inner dimensions of the sleeve 30 are slightly larger than corresponding outer dimensions of the step member 16 to allow the step member 16 to slide within the sleeve 30. In the depicted embodiment stop members 32, 34 are located on either end of the step member 16 to prevent the step member 16 from accidentally completely disengaging from the sleeve.

In the depicted embodiment, a bracket assembly 36 is used to bolt the sleeve 30 over the main center frame member of the trailer. The bracket assembly includes bolts 38 that extend downward from the bottom of the sleeve 30 and clamp bar(s) 40 that engage the bolts and clamp the sleeve 30 to the trailer frame. Referring to FIG. 5, the bracket mounting assembly includes one clamp bar; the clamp bar engages two bolts that extend downward from the sleeve.

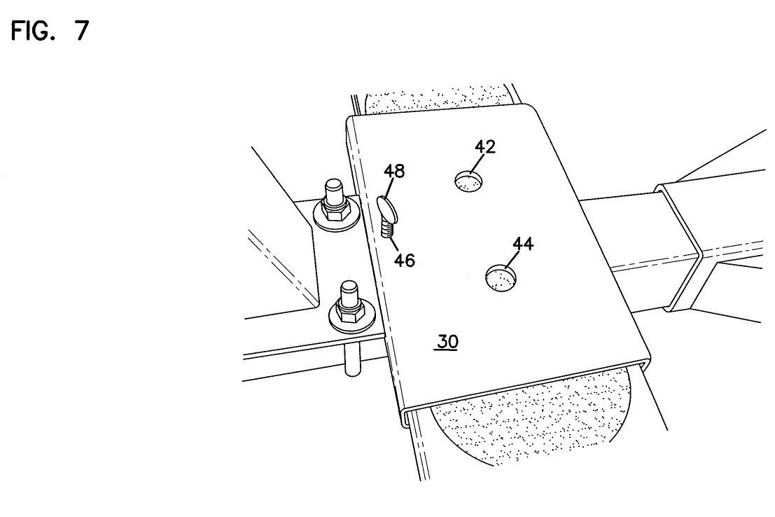

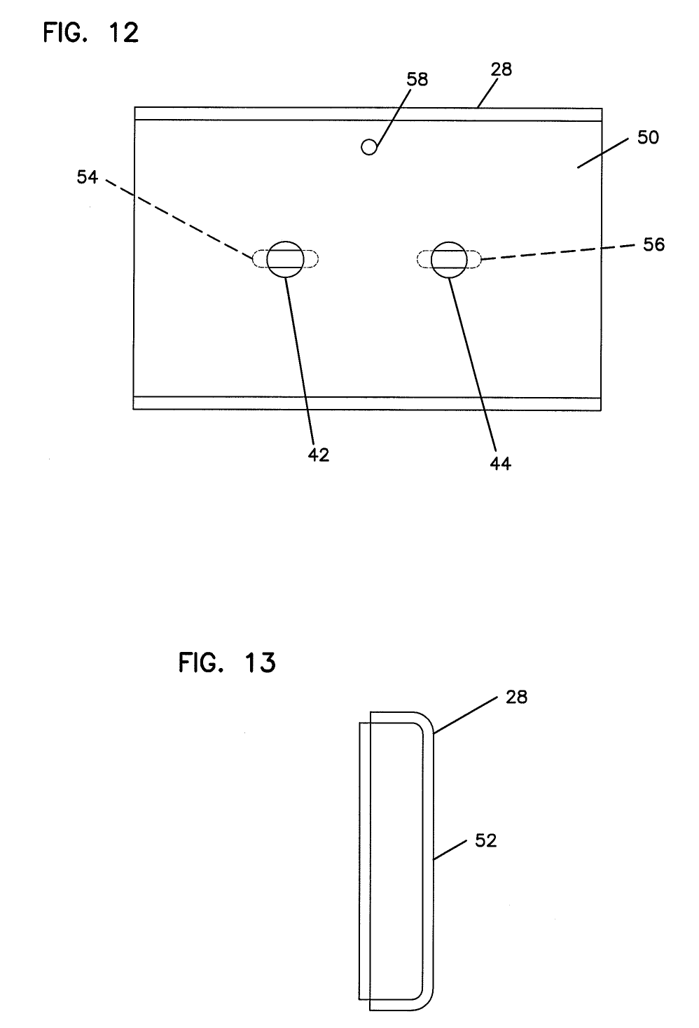

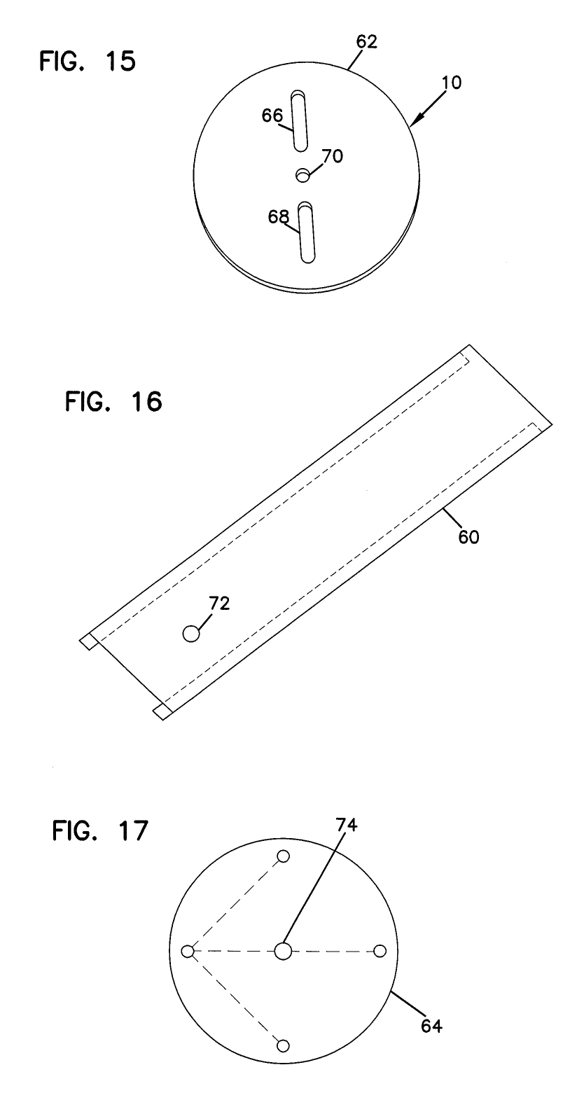

Referring to FIG. 7, the depicted embodiment of the sleeve 30 includes two apertures 42, 44 on the top surface configured to be aligned with slots (FIGS. 12 and 17) on the lower surface of the sleeve 30. The two apertures 42 and 44 are for inserting and removing the bolts 38 from the sleeve 30. The sleeve 30 includes a third aperture 46 which is threaded to receive a set screw 48. The set screw is configured to hold the step member in the desired left-to-right position or center position.

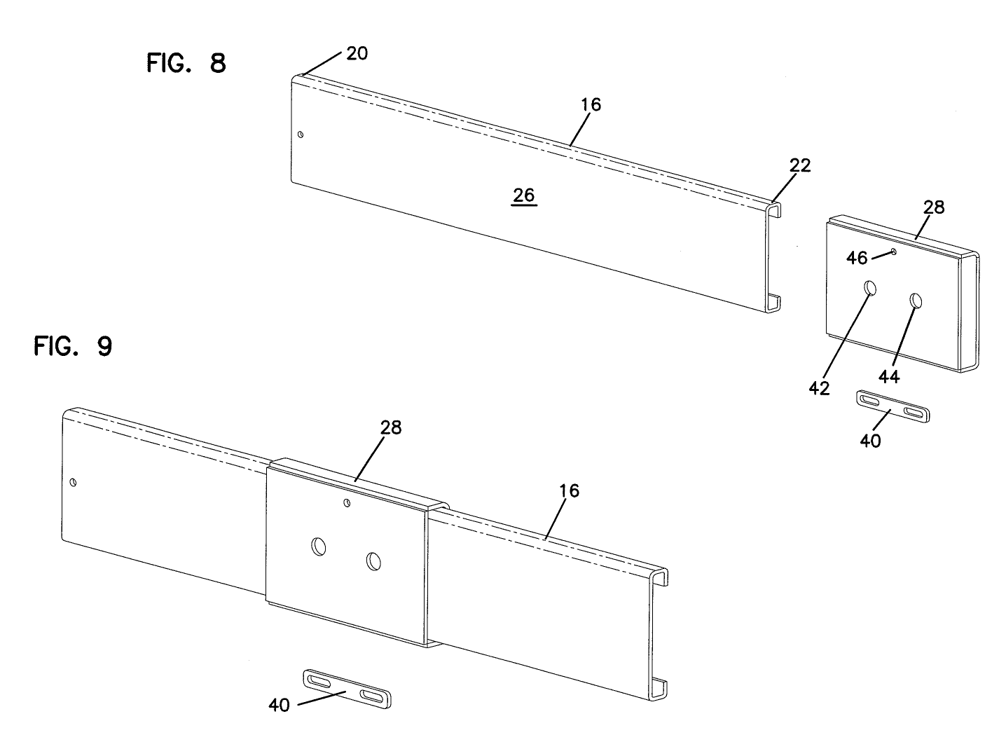

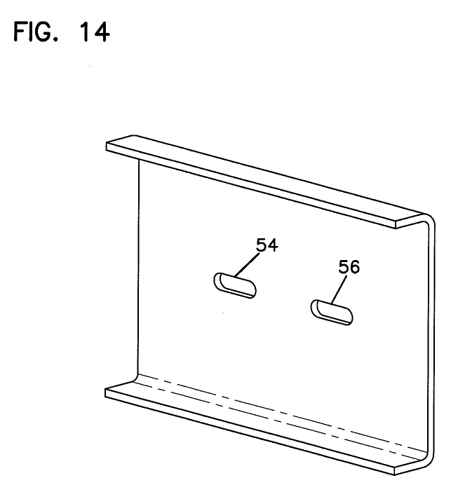

Referring to FIGS. 8-14, the components of the above-described embodiments are shown and described in greater detail. In particular, FIG. 8 is an exploded assembly view of step member 16 and components of the step mounting assembly 28. The sleeve 30 and clamp bar 40 of the step mounting assembly 28 are shown. FIG. 9 illustrates that sleeve 30 is configured to slide over the step member 16.

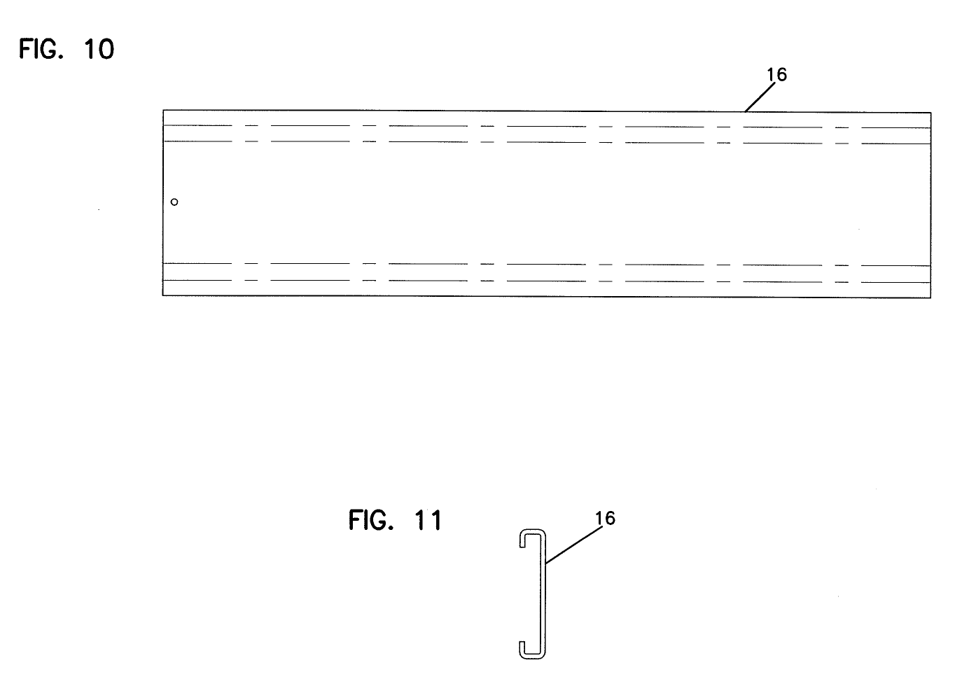

Referring to FIGS. 10-11 construction of the step member is illustrated. In the depicted embodiment the step member is constructed of a rectangular sheet of metal that is bent so that the end profile includes a generally C-shaped profile as shown. In the depicted embodiment the step member is configured so that the width of the step surface is between about 4 to 10 inches (e.g., 6 inches), the height of the step member is about ½ to 2 inches (e.g., 1 inch), and the length is between about 1 to 8 feet (e.g., 3 feet). It should be appreciated, that many other sizes and shapes are also possible. For example, the length of the step member in some preferred embodiments is between 2 to 6 feet. In still other preferred embodiments the length of the step member is between 2 to 4 feet.

Referring to FIGS. 12-14, the sleeve 30 is shown and described in greater detail. In the depicted embodiment the sleeve has a box shaped end profile that is configured to slide over the end of the step member 16. In the depicted embodiment the sleeve 30 includes an upper rectangular top member 50 and a lower U-shaped member 52 that is welded to the top member 50. The top member 50 includes two apertures 42 and 44 that are partially aligned with slots 54 and 56 and a third aperture 58. Bolts that squeeze the sleeve 30 to the clamp bar 40 are drop into the sleeve through apertures 42 and 44. The shaft of the bolts slide through the slots 54 and 56 and the head of the bolt engages the upper surface of the U-shaped member. The shaft of the bolt slides through slots on the clamp member and engage nuts. Tightening the bolts moves the clamp member towards the sleeve 30 and squeezes the frame member therebetween. The third aperture 58 is threaded and configured to engage a set screw that secures the step member 16 laterally to the sleeve 30.

It should be appreciated that although the illustrated embodiment shows the sleeve attached over the frame member of a trailer, the sleeve is configured such that it can be attached with a claim member to any beam member. For example, in an alternative embodiment, the sleeve could be attached to the hitch receiver of a motor vehicle (e.g., a pickup truck). In such an embodiment, the step would also make it easier for a person to get into or out of the bed portion of the truck.

In the depicted embodiment the length of the sleeve is about 8-12 inches (e.g., 10 inches), the outer width of the sleeve is about 4 to 10 inches (e.g., 6.5 inches), the radius of the aperture 42, 44, is about ½ to 1 inch (e.g., ¾ inch or ⅞ inch), the radius of the third aperture is about 3/16 to 7/16 of an inch (e.g. 5/16 inch), the slots 54 and 56 are about 1 to 1.5 inches long (e.g., 1.375 inches). It should be appreciated that the sleeve 30 and the components thereon can be of many alternative sizes and shapes.

Referring to FIGS. 15-17, an alternative embodiment of the step system is shown. In the depicted embodiment, the step system includes a step member 60, a base plate 62, and a top plate 64. In the depicted embodiment, base plate 62 is configured to be secured to a frame member of trailer via bolts that extend through the slots 66 and 68 and engage a clamp member. The step member 60 slides over the base plate 62 and the center bolt 70 extends through an aperture 72 on the step member 60 and through an aperture 74 on the top plate 64. The top plate 64 is tightened down on the center bolt 70 to at least partially secure the step member 60 to the base plate 62. In the depicted embodiment the top plate supports one or more set screws that help secure the step member 60 in place.

It should be appreciated that features of the first embodiment can be combined with features of the second embodiment resulting in a step that can pivot and also slide from side to side. It should also be appreciated that many other sliding and/or pivoting configurations are also possible.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A trailer for a watercraft comprising:
a chassis including a rear end portion and a front end portion, wherein the front end is configured to pivotally attach to a motor vehicle and the rear end is supported on wheels; and
a step attached to the front end portion of the chassis, the step including a first and a second end,
wherein the step is configured such that at least one of the first or second ends can be extend at least 1 foot from a centerline of the chassis, and wherein the position of the step relative to the chassis is adjustable.

2. The trailer of claim 1, wherein the step is configured to pivot relative to the chassis.

3. The trailer of claim 1, wherein the step is configured such that at least one of the first or second ends can be extended from between about two to six feet from a centerline of the chassis.

4. The trailer of claim 1, further comprising a set screw for setting the extension of the step relative to the chassis.

5. The trailer of claim 1, wherein the step is configured such that it can be configured so that either the first or the second end is extend from the center of the chassis.

6. The trailer of claim 1, wherein the step is mounted to the chassis over the centerline of the chassis.

7. A step accessory comprising:
a step member that includes a textured step surface including a first end and an opposed second end; and
a step mounting assembly configured to secure the step member over a beam member, the step mounting assembly including a mounting member including two apertures therein for receiving bolts for mounting the channel member to the beam member,
wherein the step member is configured to slide relative to the step mounting member so that the position of the step member can be adjusted relative to the beam member.

8. The step accessory of claim 7, wherein the step mounting member includes a circular periphery with a portion that has a diameter that is less than the inner width of the step member, wherein the mounting member is configured such that the step member slides over the portion of the step mounting member and pivots relative to the mounting member.

9. The step accessory of claim 8, wherein the step mounting assembly further comprises a hold down member configured to be positioned over the step member and connected to the mounting member.

10. The step accessory of claim 9, wherein the hold down member is threaded to the mounting member and includes at least one set screw that is configured to engage the step member.

11. The step accessory of claim 7, wherein the step mounting member includes a box shaped cross section that is sized to slidably receive the step member.

12. The step accessory of claim 11, wherein the box shaped cross section includes an upper plate member and a lower plate member connected by a pair of side walls, wherein the upper plate member includes two spaced apart apertures therein and the lower plate member includes a pair of apertures therein that are at least partially aligned with the apertures in the upper plate member.

13. The step accessory of claim 12, wherein the apertures in the upper plate member are generally circular and the apertures in the lower plate member are elongated.

14. The step accessory of claim 7, wherein the step member further comprises side walls along opposed longitudinal edges and wherein the lower edges of the side walls are curved towards each other.

15. The step accessory of claim 7, wherein the beam member is a portion of a receiver of a motor vehicle.

16. A method of launching a boat from a trailer comprising:
extending a step from the side of the trailer; and
pushing the boat off the trailer while standing on the extending step;

17. The method of claim 16, wherein the step of extending the step includes extending the step from the side of the trailer that is adjacent a dock; further comprising stepping off the dock directly onto the extending step.

18. The method of claim 16, wherein the step of extending the step includes pivoting the step away from the trailer.

19. The method of claim 16, wherein the step of extending the step includes sliding a step member relative to a mounting member.

20. The method of claim 16, further comprising winching the boat onto the trailer while standing on the extended step.

21. The method of claim 19, further comprising bolting the mounting member onto the trailer.
